(19) United States
(12) Patent Application Publication
(10) Pub. No.: US 2020/0334863 A1
(43) Pub. Date: Oct. 22, 2020

(54) CONTROL METHOD FOR PHOTOGRAPHING APPARATUS, MULTISPECTRAL PHOTOGRAPHING DEVICE, UNMANNED AERIAL VEHICLE, AND MEDIUM

(71) Applicant: AUTEL ROBOTICS CO., LTD., Shenzhen (CN)

(72) Inventor: Zhaozao LI, Shenzhen (CN)

(21) Appl. No.: 16/915,108

(22) Filed: Jun. 29, 2020

Related U.S. Application Data
(63) Continuation of application No. PCT/CN2018/102763, filed on Aug. 28, 2018.

(30) Foreign Application Priority Data
Dec. 29, 2017 (CN) 2017114705675

(51) Int. Cl. G06T 7/00; G06T 7/90; B64C 39/02; G06T 1/60

(52) U.S. Cl. CPC G06T 7/97; G06T 7/90; B64C 2201/127; G06T 1/60; G06T 2207/10032; B64C 39/024

(57) ABSTRACT

This application provides a control method for a photographing apparatus, a multispectral photographing device, an unmanned aerial vehicle, and a medium. The method includes: transmitting a synchronization signal to a main photographing apparatus and at least one auxiliary photographing apparatus; acquiring a first image collected by the main photographing apparatus according to the synchronization signal, and acquiring a second image collected by the at least one auxiliary photographing apparatus according to the synchronization signal; and synchronously storing the first image and the second image into a storage unit through a first read-write buffer area. Therefore, images can be stored synchronously, and then an image display effect can be improved when the images are mixed.

This application is a continuation application of International Application No. PCT/CN2018/102763, filed on Aug. 28, 2018, which claims priority of Chinese Patent Application No. 201711470567.5, filed on Dec. 29, 2017, which is incorporated herein by reference in its entirely.

### BACKGROUND

### Technical Field

This application relates to the field of imaging device technologies, and in particular, to a control method for a photographing apparatus, a multispectral photographing device, an unmanned aerial vehicle, and a medium.

### Related Art

Currently, a multispectral photographing device has been widely used in the agricultural field. For example, the device is mounted on an unmanned aerial vehicle for fertilization management, pest detection, and the like. The working principle of the multispectral photographing device is: dividing a light wave from a target into several bands according to wavelengths, and then photographing images of the bands through a plurality of photographing apparatuses of the device.

The prior art provides a multispectral photographing device. A plurality of photographing apparatuses included in the device all collect images independently. Based on this, after the multispectral photographing device acquires the images collected by the plurality of photographing apparatuses, aliasing and ghosting easily occur when the multispectral photographing device mixes the images, thereby leading to the problem of a poor image display effect.

### SUMMARY

This application provides a control method for a photographing apparatus, a multispectral photographing device, an unmanned aerial vehicle, and a medium. Through the method, image aliasing and ghosting can be prevented and an image display effect can be improved.

In a first aspect, this application provides a control method for a photographing apparatus, including: transmitting a synchronization signal to a main photographing apparatus and at least one auxiliary photographing apparatus; acquiring a first image collected by the main photographing apparatus according to the synchronization signal, and acquiring a second image collected by the at least one auxiliary photographing apparatus according to the synchronization signal; and synchronously storing the first image and the second image into a storage unit through a first read-write buffer area.

Beneficial effects of this application are as follows: through the method, the multispectral photographing device can achieve synchronous storage after acquiring images collected by the photographing apparatuses, and then an image display effect can be improved when the images are mixed.

Optionally, the acquiring a first image collected by the main photographing apparatus according to the synchronization signal includes: acquiring a first image associated with the synchronization signal in N frames of images collected by the main photographing apparatus.

Optionally, the acquiring a second image collected by the at least one auxiliary photographing apparatus according to the synchronization signal includes: acquiring a second image collected by the at least one auxiliary photographing apparatus after being triggered by the synchronization signal.

Optionally, the synchronously storing the first image and the second image into a storage unit through a first read-write buffer area includes: buffering the first image and the second image into the first read-write buffer area; and extracting at least two frames of images buffered from the first read-write buffer area, and storing the at least two frames of images into the storage unit, where the at least two frames of images are from at least two photographing apparatuses respectively.

Optionally, the method further includes: processing the first image and the second image respectively; and the synchronously storing the first image and the second image into a storage unit through a first read-write buffer area includes: synchronously storing the processed first and second images into the storage unit through the first read-write buffer area.

Optionally, the processing the first image and the second image respectively includes: converting the first image into first YUV data; and converting the second image into second YUV data, and extracting Y-component data from the second YUV data.

Optionally, the method further includes: converting the first YUV data into a file in a first format, and converting the Y-component data into a file in a second format, where a compression rate of the first format is greater than that of the second format; and the synchronously storing the processed first and second images into the storage unit through the first read-write buffer area includes: synchronously storing the file in the first format and the file in the second format into the storage unit through the first read-write buffer area.

Through the method, a storage pressure of the storage unit can be relieved on the one hand, and data information of each wavelength can be fully retained on the other hand.

Optionally, the method further includes: acquiring real-time images collected by the main photographing apparatus and/or the at least one auxiliary photographing apparatus; buffering the real-time images into a second read-write buffer area; extracting at least one frame of image from the second read-write buffer area; and transmitting the at least one frame of image to a display terminal, the display terminal being configured to display the at least one frame of image. In this way, when network transmission is unstable, through the method, image synchronization can be guaranteed and aliasing and ghosting can be prevented if network disconnection, congestion, or the like occurs. The display effect is then improved.

Optionally, the method further includes: processing the real-time images; and the buffering the real-time images into a second read-write buffer area includes: buffering the processed real-time images into the second read-write buffer area. Therefore, the storage pressure of the storage unit can be relieved.

A multispectral photographing device is provided below. The device may be configured to perform the control method for a photographing apparatus in the first aspect and in any one of the optional manners of the first aspect, and principles and effects thereof are not described below.

In a second aspect, this application provides a multispectral photographing device, including a processor, a main photographing apparatus, and at least one auxiliary photographing apparatus.

The processor is configured to: transmit a synchronization signal to a main photographing apparatus and at least one auxiliary photographing apparatus; acquire a first image collected by the main photographing apparatus according to the synchronization signal, and acquire a second image collected by the at least one auxiliary photographing apparatus according to the synchronization signal; and synchronously store the first image and the second image into a storage unit through a first read-write buffer area.

Optionally, the processor is specifically configured to: acquire a first image associated with the synchronization signal in N frames of images collected by the main photographing apparatus.

Optionally, the processor is specifically configured to: acquire a second image collected by the at least one auxiliary photographing apparatus after being triggered by the synchronization signal.

Optionally, the processor is specifically configured to: buffer the first image and the second image into the first read-write buffer area; and extract at least two frames of images buffered from the first read-write buffer area, and store the at least two frames of images into the storage unit.

Optionally, the processor is further configured to: process the first image and the second image respectively; and correspondingly, the processor is specifically configured to synchronously store the processed first and second images into the storage unit through the first read-write buffer area.

Optionally, the processor is specifically configured to: convert the first image into first YUV data; and convert the second image into second YUV data, and extract Y-component data from the second YUV data.

Optionally, the processor is further configured to: convert the first YUV data into a file in a first format, and convert the Y-component data into a file in a second format, where a compression rate of the first format is greater than that of the second format; and correspondingly, the processor is specifically configured to synchronously store the file in the first format and the file in the second format into the storage unit through the first read-write buffer area.

Optionally, the processing the first image and the second image respectively includes:

converting the first image into first YUV data; and

converting the second image into second YUV data.

Optionally, the method further includes:

converting the first YUV data into a file in a first format, and converting the Y-component data into a file in a second format,

where a compression rate of the first format is greater than that of the second format; and

the synchronously storing the processed first and second images into the storage unit through the first read-write buffer area includes:

synchronously storing the file in the first format and the file in the second format into the storage unit through the first read-write buffer area.

Optionally, the device further includes a transmitter, where the processor is further configured to: acquire real-time images collected by the main photographing apparatus and/or the at least one auxiliary photographing apparatus; buffer the real-time images into a second read-write buffer area; and extract at least one frame of image from the second read-write buffer area; and the transmitter is configured to transmit the at least one frame of image to a display terminal, the display terminal being configured to display the at least one frame of image.

Optionally, the processor is further configured to: process the real-time images; and the processor is specifically configured to: buffer the processed real-time images into the second read-write buffer area.

An unmanned aerial vehicle is provided below. The unmanned aerial vehicle includes the multispectral photographing device in the second aspect and in any one of the optional manners of the second aspect, and principles and effects thereof are not described below.

In a third aspect, this application provides an unmanned aerial vehicle, including: a rack, a power apparatus, and the multispectral photographing device in the second aspect and in any one of the optional manners of the second aspect, where the power apparatus is disposed on the rack and is configured to drive the unmanned aerial vehicle to fly.

In a fourth aspect, this application provides a storage medium, including: an instruction, the instruction being used to implement the control method for a photographing apparatus in the first aspect and in any one of the optional manners of the first aspect.

In a fifth aspect, this application provides a computer program product, including: a computer program, the computer program being used to implement the control method for a photographing apparatus in the first aspect and in any one of the optional manners of the first aspect.

This application provides a control method for a photographing apparatus, a multispectral photographing device, an unmanned aerial vehicle, and a medium. The method includes: transmitting a synchronization signal to a main photographing apparatus and at least one auxiliary photographing apparatus; acquiring a first image collected by the main photographing apparatus according to the synchronization signal, and acquiring a second image collected by the at least one auxiliary photographing apparatus according to the synchronization signal; and synchronously storing the first image and the second image into a storage unit through a first read-write buffer area. Therefore, the multispectral photographing device can achieve synchronous storage after acquiring images collected by the photographing apparatuses, and then an image display effect can be improved when the images are mixed.

### BRIEF DESCRIPTION OF THE DRAWINGS

To describe the technical solutions in the embodiments of the present invention or in the prior art more clearly, accompanying drawings to be used in the descriptions of the embodiments or the prior art are briefly introduced below. Apparently, the accompanying drawings in the following descriptions are merely some embodiments of the present invention. A person of ordinary skill in the art can further obtain accompanying drawings of other embodiments according to the accompanying drawings without creative efforts.

FIG. 1 is a flowchart of a control method for a photographing apparatus according to an embodiment of this application;

FIG. 2 is a schematic diagram of quantum efficiency of photographing apparatuses of a multispectral photographing device and wavelength distribution of spectrums collected by the photographing apparatuses according to an embodiment of this application;

FIG. 3 is a schematic diagram of image collection according to an embodiment of this application;

FIG. 4 is a schematic diagram of image collection according to an embodiment of this application;

FIG. 5 is a flowchart of an image processing method according to an embodiment of this application;

FIG. 6 is a flowchart of a control method for a photographing apparatus according to another embodiment of this application;

FIG. 7 is a schematic interface diagram of a display terminal according to an embodiment of this application;

FIG. 8 is a schematic diagram of a multispectral photographing device according to an embodiment of this application;

FIG. 9 is a schematic diagram of a multispectral photographing device according to another embodiment of this application;

FIG. 10 is a schematic diagram of a control system for a photographing apparatus according to another embodiment of this application; and

FIG. 11 is a schematic diagram of an unmanned aerial vehicle 110 according to an embodiment of this application.

### DETAILED DESCRIPTION

The technical solutions in the embodiments of this application are described below with reference to the accompanying drawings in the embodiments of this application. Obviously, the described embodiments are some rather than all of the embodiments of this application. All other embodiments obtained by a person of ordinary skill in the art based on the embodiments in this application without creative efforts fall within the protection scope of this application.

The terms “first,” “second,” and so on (if any) in the specification, claims, and the above accompanying drawings of this application are used to distinguish similar objects and need not be used to describe a particular order or sequence. It should be understood that data so used are interchangeable where appropriate, so that the embodiments of this application described here can be implemented, for example, in an order other than those depicted or described here. In addition, the terms “include/comprise” and “have” as well as any deformation thereof are intended to cover a non-exclusive inclusion, for example, a process, a method, a system, a product, or a device including a series of steps or units need not be limited to the clearly listed steps or units, but may include other steps or units not clearly listed or inherent to the process, method, product, or device.

Currently, the multispectral photographing device has been widely used in agriculture. A multispectral imaging technology can sense different narrow and continuous energy from visible light to thermal infrared to obtain images at specific bands, which is used to identify growth states of crops for fertilization management, pest detection, and the like. However, in the prior art, because a plurality of photographing apparatuses included in the multispectral photographing device all collect images independently, based on this, after the multispectral photographing device obtains the images collected by the plurality of photographing apparatuses, aliasing and ghosting easily occur when the multispectral photographing device mixes the images, thereby leading to the problem of a poor image display effect.

To solve the above technical problem, this application provides a control method for a photographing apparatus, a multispectral photographing device, an unmanned aerial vehicle, and a medium.

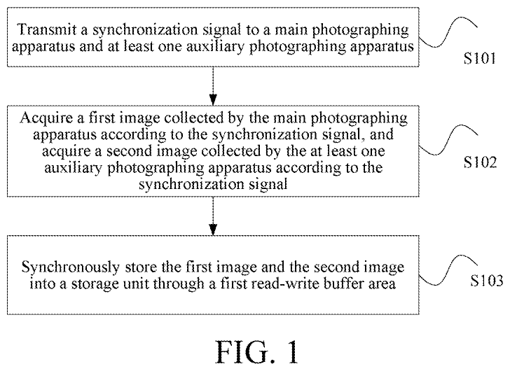

Specifically, FIG. 1 is a flowchart of a control method for a photographing apparatus according to an embodiment of this application. The method may be performed by a processor in a multispectral photographing device. The processor may be one or more Application Specific Integrated Circuits (ASICs), a Digital Signal Processor (DSP), a Digital Signal Processing Device (DSPD), a Programmable Logic Device (PLD), a Field-Programmable Gate Array (FPGA), a controller, a microcontroller, a microprocessor, a Central Processing Unit (CPU), a Graphics Processing Unit (GPU), other electronic elements, or the like, or a combination of the above elements. This is not limited in this application.

The multispectral photographing device includes a main photographing apparatus and at least one auxiliary photographing apparatus.

The processor may be coupled to the main photographing apparatus and the at least one auxiliary photographing apparatus. For example, the processor may be coupled to the main photographing apparatus and the at least one auxiliary photographing apparatus through a bus or the like.

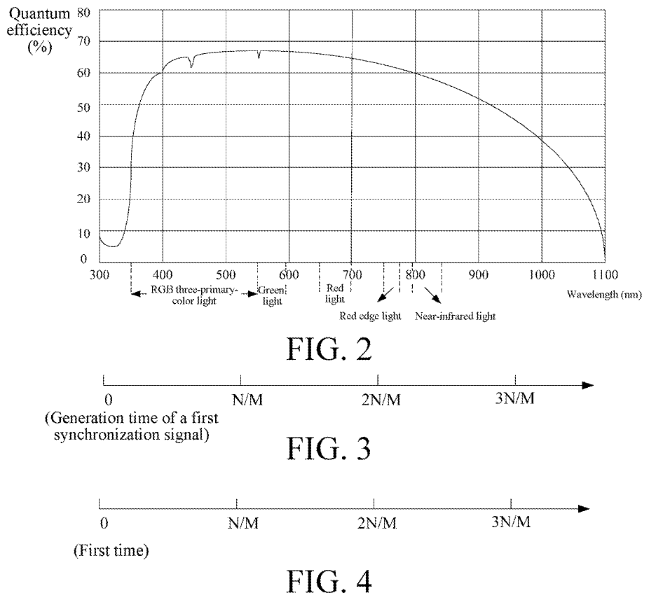

Optionally, FIG. 2 is a schematic diagram of quantum efficiency of photographing apparatus of a multispectral photographing device and wavelength distribution of spectrums collected by the photographing apparatus according to an embodiment of this application. As shown in FIG. 2, the main photographing apparatus is configured to collect ultra-high-definition three-primary colors of Red Green Blue (RGB), and it may acquire on-site images visually accessible to human eyes. The at least one auxiliary photographing apparatus is configured to collect green light (with a wavelength of 550 nanometers (nm)), red light (with a wavelength of 660 nm), red edge light (with a wavelength of 735 nm), near-infrared light (with a wavelength of 790 nm), and so on.

Optionally, the at least one auxiliary photographing apparatus may collect images by global exposure.

Based on this, as shown in FIG. 1, the method includes the following steps.

In step S101, a synchronization signal is transmitted to a main photographing apparatus and at least one auxiliary photographing apparatus.

In step S102, a first image collected by the main photographing apparatus according to the synchronization signal is acquire, and a second image collected by the at least one auxiliary photographing apparatus according to the synchronization signal are acquired.

In step S103, the first image and the second image are synchronously stored into a storage unit through a first read-write buffer area.

Descriptions are provided in combination with step S101 and step S102.

For example, the synchronization signal is used to trigger the main photographing apparatus and the at least one auxiliary photographing apparatus to synchronously collect the first image and the second image. Specifically, the synchronization signal is used to trigger the main photographing apparatus and the at least one auxiliary photographing apparatus to immediately synchronously collect the first image and the second image upon receipt of the synchronization signal. That is, the receiving time of the synchronization signal is the time when the main photographing apparatus and the at least one auxiliary photographing apparatus collect the first image and the second image respectively. Alternatively, the synchronization signal carries time information T. The synchronization signal is used to trigger the main photographing apparatus and the at least one auxiliary photographing apparatus to synchronously collect the first image and the second image at the time T.

Further, to acquire a multi-frame first image and a multi-frame second image, the processor may periodically transmit the synchronization signal, and the main photographing apparatus transmits the first image to the processor each time the synchronization signal is received; similarly, the auxiliary photographing apparatus transmits the second image to the processor each time the synchronization signal is received.

Generally, a frame rate of the main photographing apparatus is greater than that of each auxiliary lens. A frame rate of a photographing apparatus refers to the number of frames of images shot or collected by the photographing apparatus per second. For example, the frame rate of the main photographing apparatus may be N frames per second, and the frame rate of at least one auxiliary photographing apparatus may be M frames per second, where N is greater than M and N is an integer multiple of M. Frame rates of the auxiliary photographing apparatus are the same, that is, all are M.

Based on this, the acquiring, by the processor, a first image collected by the main photographing apparatus according to the synchronization signal includes: acquiring, by the processor, a first image associated with the synchronization signal in N frames of images shot by the main photographing apparatus.

For example, the main photographing apparatus shoots N frames of images in one second, and during the photographing, the main photographing apparatus immediately transmits a first image currently collected to the processor upon receipt of the synchronization signal, or the main photographing apparatus transmits, according to the time information T indicated by the synchronization signal, a first image currently collected to the processor at the time T.

Similarly, the acquiring, by the processor, a second image collected by the at least one auxiliary photographing apparatus according to the synchronization signal includes: acquiring, by the processor, a second image collected by the at least one auxiliary photographing apparatus after being triggered by the synchronization signal.

For example, an auxiliary photographing apparatus shoots M frames of images in one second, and during the photographing, the main photographing apparatus immediately transmits a first image currently collected to the processor upon receipt of the synchronization signal, or the auxiliary photographing apparatus transmits, according to the time information T indicated by the synchronization signal, a second image currently collected to the processor at the time T.

Further, to synchronously acquire more first images and second images, the processor may set a transmission frequency of the synchronization signal equal to the frame rate of the auxiliary photographing apparatus, that is, all are M. The auxiliary photographing apparatus shoots an image each time the auxiliary photographing apparatus receives the synchronization signal, and transmits the shot image to the processor. The main photographing apparatus may be provided with a crystal oscillator, then the main photographing apparatus shoots an image according to its own clock signal, and the main photographing apparatus may collect an image according to the synchronization signal and transmit the collected image to the processor.

For example, starting from the generation time of a first synchronization signal, the auxiliary photographing apparatus transmits each frame of image shot by it to the processor, and the main photographing apparatus transmits an image shot by it to the processor every N/M seconds. Specifically, FIG. 3 is a schematic diagram of image collection according to an embodiment of this application. As shown in FIG. 3, assuming that the generation time of the first synchronization signal is recorded as 0, the main photographing apparatus transmits an image shot by it to the processor once at N/M, 2N/M, and 3N/M. Therefore, the processor is ensured to synchronously acquire images collected by the main photographing apparatus and the auxiliary photographing apparatus, and when the multispectral photographing device subsequently displays the images, aliasing and ghosting can be prevented based on the technical method provided in this application when the images are mixed.

Alternatively, from a first time, the auxiliary photographing apparatus transmits each frame of image shot by it to the processor, and the main photographing apparatus transmits an image shot by it to the processor every N/M seconds. The first time is any moment after the generation time of the first synchronization signal. Specifically, FIG. 4 is a schematic diagram of image collection according to an embodiment of this application. As shown in FIG. 4, assuming that the first time is recorded as 0, the main photographing apparatus transmits an image shot by it to the processor once at N/M, 2N/M, and 3N/M. Therefore, the processor is ensured to synchronously acquire images collected by the main photographing apparatus and the auxiliary photographing apparatus, and when the multispectral photographing device subsequently displays the images, aliasing and ghosting can be prevented based on the technical method provided in this application when the images are mixed.

It should be noted that the first synchronization signal is used to trigger the main photographing apparatus and the auxiliary photographing apparatus to start to synchronously collect a first frame of image, and the main photographing apparatus does not need to collect an image according to the first synchronization signal when photographing the image subsequently because the main photographing apparatus has its own crystal oscillator; on the contrary, the auxiliary photographing apparatus need to shoot an image according to respective synchronization signals after the first synchronization signal because the auxiliary photographing apparatus do not have their own crystal oscillators.

Step S103 are described as follows: in consideration of the increasing number of photographing apparatus in the current multispectral photographing device and the increasing number of images collected by the photographing apparatus, image synchronization may not be achieved if the acquired images are directly stored in the storage unit; therefore, in this application, the processor synchronously stores the first image and the second image into the storage unit through the first read-write buffer area. Specifically, step 103 includes: buffering the first image and the second image into the first read-write buffer area; and extracting at least two frames of images buffered from the first read-write buffer area, and storing the at least two frames of images into the storage unit. The at least two frames of images are from at least two photographing apparatus respectively. For example, the processor acquires the first image from the main photographing apparatus and acquires the second image from the auxiliary photographing apparatus, the processor may buffer the first image and the second image into a read-write buffer area, and then the buffered images in the read-write buffer area can be synchronously stored in the storage unit.

The first read-write buffer area may be a storage area in a Double Data Rate (DDR) synchronous dynamic random access memory, or other buffer units or buffer areas that support read-write, which is not limited herein.

The storage unit may be a Static Random Access Memory (SRAM), an Electrically Erasable Programmable Read-Only Memory (EEPROM), an Erasable Programmable Read-Only Memory (EPROM), a Programmable read-only memory (PROM), a Read-Only Memory (ROM), a magnetic memory, a Trans-flash Card (TF), a hard disk memory, a magnetic disk, an optical disc, or the like.

Optionally, the multispectral photographing device may further include a display. The display may display images mixed by the processor, or the display displays the images in a single channel or multiple channels. The so-called “displaying the images in a single channel” means displaying an image collected by any photographing apparatus of the multispectral photographing apparatus, or displaying a mixed image of images collected by at least two photographing apparatus. The so-called “displaying the images in multiple channels” means simultaneously displaying images collected by at least two photographing apparatus.

Based on the above, this application provides a control method for a photographing apparatus, including: transmitting a synchronization signal to a main photographing apparatus and at least one auxiliary photographing apparatus; acquiring a first image collected by the main photographing apparatus according to the synchronization signal, and acquiring a second image collected by the at least one auxiliary photographing apparatus according to the synchronization signal; and synchronously storing the first image and the second image into a storage unit through a first read-write buffer area, so that after the multispectral photographing device acquires the images collected by the photographing apparatus, an image display effect can be improved when the images are mixed.

Further, because a light wavelength of an RGB three-primary-color image collected by the main photographing apparatus traverses from 300 nm to 800 nm, its color component is rich; however, as it is an ultra-high-definition image, the amount of original data of the RGB image is too large. If the original data of the RGB image is stored in the storage unit, a certain storage pressure may be brought to the storage unit. Similarly, due to the large amount of original data of images collected by each auxiliary lens, a certain storage pressure may also be brought to the storage unit. Therefore, in this application, the processor may process the first image and the second image to achieve image compression, and then synchronously store the processed first and second images into the storage unit through the first read-write buffer area. The processor processes the first image and the second image specifically in the following two optional manners.

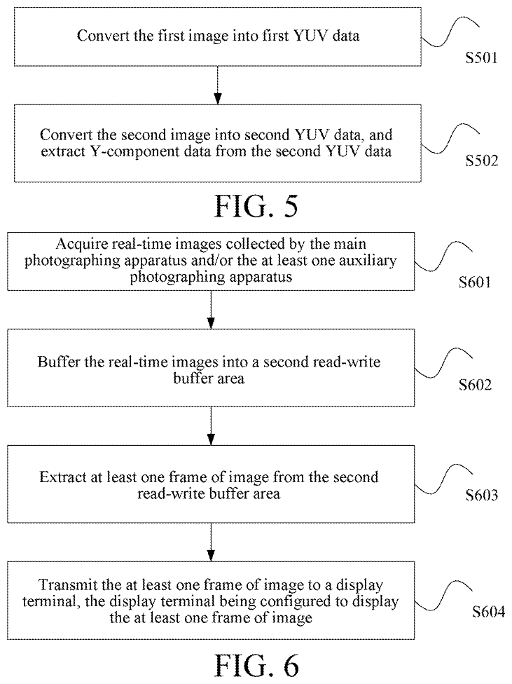

Optional manner 1: FIG. 5 is a flowchart of an image processing method according to an embodiment of this application. As shown in FIG. 5, the method includes the following process:

In step S501, the first image is converted into first YUV data.

In step S502, the second image is converted into second YUV data, and Y-component data is extracted from the second YUV data.

Optionally, the processor performs YUV encoding on the first image (RGB image) to obtain first YUV data and convert the first YUV data into a file in a first format. For example, the format is a Joint Photographic Experts Group (JEPG) format. Other auxiliary photographing apparatus respectively collect green light (with a wavelength of 550 nm and a bandwidth of 40 nm), red light (with a wavelength of 660 nm and a bandwidth of 40 nm), red edge light (with a wavelength of 735 nm and a bandwidth of 10 nm), near-infrared light (with a wavelength of 790 nm and a bandwidth of 40 nm), and so on. Beams of the light all have a narrow bandwidth, which means that they have very little color information. To reduce the amount of data stored and fully display data characteristics of the wavelengths, the processor converts the second image collected by the auxiliary photographing apparatus into second YUV data and converts Y-component data in the second YUV data into a file in a second format. A compression rate of the second format is less than that of the first format, for example, the second format is a Tag Image File Format (TIFF). In this way, a storage pressure of the storage unit can be relieved on the one hand, and data information of each wavelength can be fully retained on the other hand.

Correspondingly, the synchronously storing the processed first and second images into the storage unit through the first read-write buffer area includes: synchronously storing the file in the first format and the file in the second format into the storage unit through the first read-write buffer area.

Optional manner 2: the first image is converted into first YUV data; and the second image is converted into second YUV data. Further, the control method for a photographing apparatus further includes: converting, by the processor, the first YUV data into in a file in a first format, and converting the Y-component data into a file in a second format, where a compression rate of the first format is greater than that of the second format; and the synchronously storing the processed first and second images into the storage unit through the first read-write buffer area includes: synchronously storing the file in the first format and the file in the second format into the storage unit through the first read-write buffer area.

Based on the above, in this application, the control method for a photographing apparatus further includes: processing, by the processor, the first image and the second image. Based on this, the processor can synchronously store the processed first and second images into the storage unit through the first read-write buffer area. Through the method, a storage pressure of the storage unit can be relieved on the one hand, and data information of each wavelength can be fully retained on the other hand.

Further, the multispectral photographing device may further transmit, in real time, the images collected by the main photographing apparatus and the auxiliary photographing apparatus to a display terminal to make the display terminal display the images. The display terminal is also referred to as a remote device or a terminal device. The display device may be a computer, a tablet computer, a mobile phone, or other display terminals with a display screen. In consideration of the increasing number of photographing apparatus in the current multispectral photographing device and the increasing number of images collected by the photographing apparatus, if the acquired images are directly stored in the storage unit, the images are not synchronized, resulting in aliasing and ghosting. Based on this, this application further provides a control method for a photographing apparatus. FIG. 6 is a flowchart of a control method for a photographing apparatus according to another embodiment of this application. The control method for a photographing apparatus includes the following steps.

In step S601, real-time images collected by the main photographing apparatus and/or the at least one auxiliary photographing apparatus are acquired.

In step S602, the real-time images are buffered into a second read-write buffer area.

In step S603, at least one frame of image is extracted from the second read-write buffer area.

In step S604, the at least one frame of image is transmitted to a display terminal, the display terminal being configured to display the at least one frame of image.

Optionally, before step S602, the method further includes: processing, by the processor, the real-time images; and correspondingly, step S602 specifically includes: buffering the processed real-time images into the second read-write buffer area.

The processing, by the processor, the real-time images specifically includes: converting, by the processor, the real-time images into YUV data, reducing the images, for example, to 1080P, 960P, 720P, or even a size of a Video Graphics Array (VGA), then encoding the reduced images by using an H265 or H264 standard to obtain code streams, and buffering the code streams into the second read-write buffer area. The code stream includes: a Sequence Parameter Set (SPS), a Picture Parameter Set (PPS), and other syntax structures. The SPS may include parameters that apply to zero or more sequences. The PPS may include parameters that apply to zero or more pictures. The syntax structure is a set of zero or more syntax elements arranged in a specified order in the code stream. The code stream further includes other existing information, which is not described in this application.

The second read-write buffer area may be a storage area in the DDR and may be in the same memory as the first read-write buffer area, except that the second read-write buffer area and the first read-write buffer area are different storage areas in the same memory. For example, the second read-write buffer area and the first read-write buffer area are different storage areas in the DDR. Certainly, the second read-write buffer area and the first read-write buffer area may also be located in different memories, which is not limited in this application.

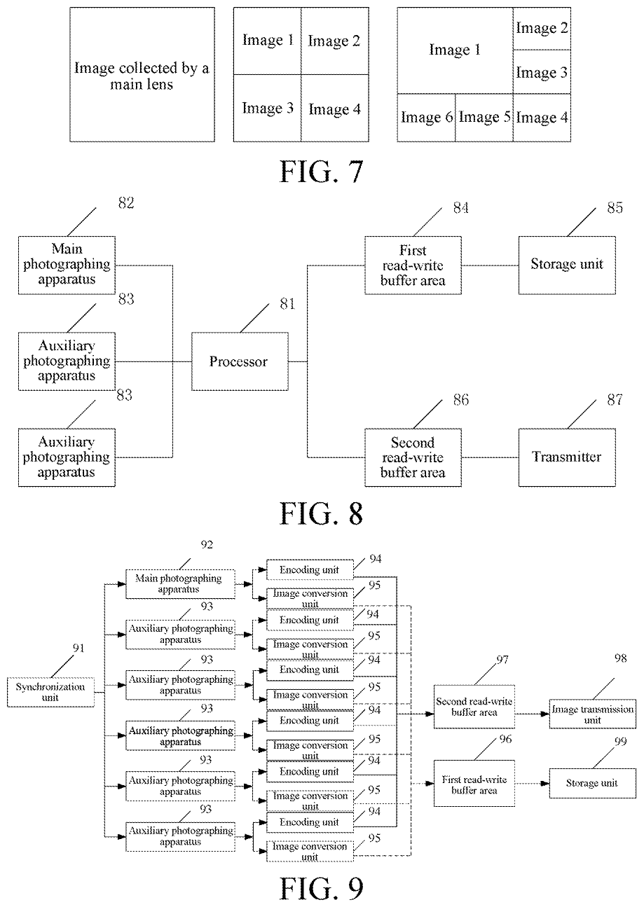

When all the code streams have been stored in the second read-write buffer area, the processor may extract code stream information corresponding to at least one frame of image from the second read-write buffer area and transmit the code stream information to the display terminal. Therefore, the display terminal processes, for example, mixes, the acquired images, and then displays a mixed image, or the display terminal does not mix the images but displays the images in a single channel or multiple channels. Specifically, FIG. 7 is a schematic interface diagram of a display terminal according to an embodiment of this application. As shown in FIG. 7, the leftmost image is an image collected by a main photographing apparatus displayed by the display terminal, four images in the middle are images respectively collected by four auxiliary photographing apparatus displayed by the display terminal, and the rightmost images 1 to 7 are images collected by the main photographing apparatus and six auxiliary photographing apparatus respectively.

Further, a frame rate of the main photographing apparatus is greater than that of the auxiliary photographing apparatus, for example, the frame rate of the main photographing apparatus is 30, which is higher, so an RGB image displayed in the display terminal is relatively smooth. The frame rate of other auxiliary photographing apparatus is 2, and the display terminal may be prone to lag or the like when displaying an image. In this case, the display terminal can further push an alarm message to prompt a user abnormal image display occurs in which of the auxiliary photographing apparatus. Both the alarm message and the abnormal image may be displayed on the display terminal, so that the user can directly see the abnormal image display occurs in which of the auxiliary photographing apparatus.

It should be noted that step S101 to step S103 and step S601 to step S604 are two independent solutions. The multispectral photographing device may execute either of the two solutions alone, or concurrently execute the two solutions, which is not limited in this application.

Based on the above, this application provides a multispectral photographing method, including: acquiring real-time images collected by the main photographing apparatus and/or the at least one auxiliary photographing apparatus; buffering the real-time images into a second read-write buffer area; extracting at least one frame of image from the second read-write buffer area; and transmitting the at least one frame of image to a display terminal. In this way, when network transmission is unstable, through the method, image synchronization can be guaranteed and aliasing and ghosting can be prevented if network disconnection, congestion, or the like occurs. The display effect is then improved.

It should be noted that in the above embodiments, the synchronization signal is used to trigger the main photographing apparatus and the at least one auxiliary photographing apparatus to synchronously collect the first image and the second image. If the processor needs to acquire a multi-frame first signal and a multi-frame second image, the synchronization signal needs to be periodically transmitted. To save signaling overheads, this application further provides a control method for a photographing apparatus. The method is applied to the following scenario: the frame rate of the main photographing apparatus is N frames per second, and the frame rate of at least one auxiliary photographing apparatus may be M frames per second, where N is greater than M, and N is an integer multiple of M. Based on the scenario, the control method for a photographing apparatus includes: firstly, a processor transmits trigger information to a main photographing apparatus and at least one auxiliary photographing apparatus, and synchronously starting, by the main photographing apparatus and the at least one auxiliary photographing apparatus, to shoot a first-frame image according to the trigger information respectively. In a case, after receiving the trigger information (the receiving time of the trigger information is recorded as 0), the main photographing apparatus and the at least one auxiliary photographing apparatus immediately start to shoot the first-frame image. In another case, after receiving the trigger information (the trigger information carries time information T, and the time T is recorded as 0), the main photographing apparatus and the at least one auxiliary photographing apparatus start to shoot the first-frame image at the time T. Secondly, the processor acquires each frame of image shot by the auxiliary photographing apparatus, and acquires an image transmitted by the main photographing apparatus at time N/M, 2N/M, and 3N/M. Finally, the processor synchronously stores the acquired images into a storage unit through a first read-write buffer area.

Based on the above, this application provides a control method for a photographing apparatus, including: transmitting, by a processor, trigger information to a main photographing apparatus and at least one auxiliary photographing apparatus, and starting, by the main photographing apparatus and the at least one auxiliary photographing apparatus, to shoot a first-frame image according to the trigger information respectively; and acquiring, by the processor, each frame of image shot by the auxiliary photographing apparatus, and acquiring an image transmitted by the main photographing apparatus at N/M, 2N/M, and 3N/M, and synchronously storing, by the processor, the acquired images into a storage unit through a first read-write buffer area. Through the method, on the one hand, after the multispectral photographing device acquires images collected by photographing apparatus, aliasing and ghosting may not occur when the images are mixed, so as to improve an image display effect. On the other hand, because the processor can acquire multiple frames of images from the photographing apparatus only by transmitting trigger information, thereby reducing signaling overheads of the processor.

FIG. 8 is a schematic diagram of a multispectral photographing device according to an embodiment of this application. As shown in FIG. 8, the device includes: a processor 81, a main photographing apparatus 82, at least one auxiliary photographing apparatus 83 (for example, two auxiliary photographing apparatus are included in the figure), a first read-write buffer area 84, and a storage unit 85.

The processor 81 is configured to: transmit a synchronization signal to the main photographing apparatus 82 and the at least one auxiliary photographing apparatus 83; acquiring a first image collected by the main photographing apparatus 82 according to the synchronization signal, and acquiring a second image collected by the at least one auxiliary photographing apparatus 83 according to the synchronization signal; and synchronously storing the first image and the second image into the storage unit 84 through the first read-write buffer area 85.

Optionally, the processor 81 is specifically configured to: acquire a first image associated with the synchronization signal in N frames of images collected by the main photographing apparatus 82.

Optionally, the processor 81 is specifically configured to: acquire a second image collected by the at least one auxiliary photographing apparatus 83 after being triggered by the synchronization signal.

Optionally, the processor 81 is specifically configured to: buffer the first image and the second image into the first read-write buffer area; and extract at least two frames of images buffered from the first read-write buffer area 84, and store the at least two frames of images into the storage unit 85.

Optionally, the processor 81 is further configured to: process the first image and the second image respectively; and correspondingly, the processor 81 is specifically configured to: synchronously store the processed first and second images into the storage unit 85 through the first read-write buffer area 84.

Optionally, the processor 81 is specifically configured to: convert the first image into first YUV data; and convert the second image into second YUV data, and extract Y-component data from the second YUV data.

Optionally, the processor 81 is further configured to: convert the first YUV data into a file in a first format, and convert the Y-component data into a file in a second format, where a compression rate of the first format is greater than that of the second format; and the processor 81 is specifically configured to: synchronously store the file in the first format and the file in the second format into the storage unit 85 through the first read-write buffer area 84.

The device further includes: a second read-write buffer area 86 and a transmitter 87.

The processor 81 is further configured to: acquire real-time images collected by the main photographing apparatus 82 and/or the at least one auxiliary photographing apparatus 82; buffer the real-time images into the second read-write buffer area 86; and extract at least one frame of image from the second read-write buffer area 86; and the transmitter 87 is configured to transmit the at least one frame of image to a display terminal, the display terminal being configured to display the at least one frame of image.

Optionally, the processor 81 is further configured to: process the real-time images; and the processor 81 is specifically configured to: buffer the processed real-time images into the second read-write buffer area.

The multispectral photographing device provided in this application is configured to perform the control method for a photographing apparatus, and principles and effects thereof are not described herein.

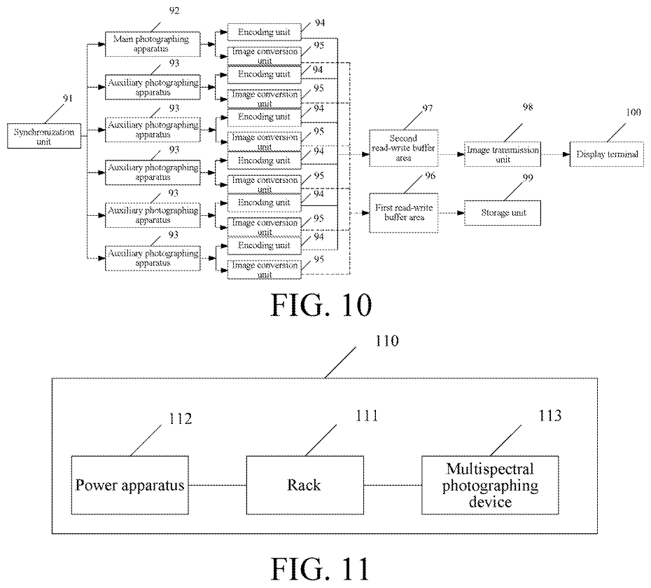

FIG. 9 is a schematic diagram of a multispectral photographing device according to another embodiment of this application. As shown in FIG. 9, the device includes: a synchronization unit 91, a main photographing apparatus 92, at least one auxiliary photographing apparatus 93 (for example, five auxiliary photographing apparatus are included in the figure), a plurality of encoding units 94, a plurality of image conversion units 95, a first read-write buffer area 96, a second read-write buffer area 97, an image transmission unit 98, and a storage unit 99.

The synchronization unit 91 is configured to: transmit a synchronization signal to the main photographing apparatus 92 and the at least one auxiliary photographing apparatus 93. The image conversion unit 95 corresponding to the main photographing apparatus 92 is configured to: acquire a first image collected by the main photographing apparatus 92 according to the synchronization signal. The image conversion unit 95 corresponding to the auxiliary photographing apparatus 93 is configured to: acquire a second image collected by the auxiliary photographing apparatus 93 according to the synchronization signal. The image conversion units 95 synchronously store the first image and the second image into the storage unit 99 through the first read-write buffer area 96.

Optionally, the image conversion unit 95 corresponding to the main photographing apparatus 92 is specifically configured to: acquire a first image associated with the synchronization signal in N frames of images collected by the main photographing apparatus 92.

Optionally, the image conversion unit 95 corresponding to the auxiliary photographing apparatus 93 is specifically configured to: acquire a second image collected by the at least one auxiliary photographing apparatus 93 after being triggered by the synchronization signal.

Optionally, the image conversion units 95 are specifically configured to: buffer the first image and the second image into the first read-write buffer area; and extract at least two frames of images buffered from the first read-write buffer area 96, and store the at least two frames of images into the storage unit 99.

Optionally, the image conversion units 95 are further configured to: process the first image and the second image respectively; and correspondingly, the image conversion units 95 are specifically configured to synchronously store the processed first and second images into the storage unit 99 through the first read-write buffer area 96.

Optionally, the image conversion units 95 are specifically configured to: convert the first image into first YUV data; and convert the second image into second YUV data, and extract Y-component data from the second YUV data.

Optionally, the image conversion units 95 are further configured to: convert the first YUV data into a file in a first format, and convert the Y-component data into a file in a second format, where a compression rate of the first format is greater than that of the second format; and correspondingly, the image conversion units 95 are specifically configured to synchronously store the file in the first format and the file in the second format into the storage unit 99 through the first read-write buffer area 96.

The encoding units 94 are configured to: acquire real-time images collected by the main photographing apparatus 92 and/or the at least one auxiliary photographing apparatus 93; buffer the real-time images into the second read-write buffer area 97; and extract at least one frame of image from the second read-write buffer area 97. The image transmission unit 98 is configured to transmit the at least one frame of image to a display terminal, the display terminal being configured to display the at least one frame of image.

Optionally, the encoding units 94 are further configured to: process the real-time images; and the encoding units 94 are specifically configured to: buffer the processed real-time images into the second read-write buffer area 97.

The multispectral photographing device provided in this application is configured to perform the control method for a photographing apparatus, and principles and effects thereof are not described herein.

FIG. 10 is a schematic diagram of a control system for a photographing apparatus according to another embodiment of this application. As shown in FIG. 10, the system includes: the multispectral photographing device as described in the corresponding embodiment of FIG. 9 and a display terminal 100. The image transmission unit 98 in the multispectral photographing device is configured to transmit at least one frame of image to the display terminal 100, the display terminal 100 being configured to display the at least one frame of image.

A multispectral photographing system provided in this application includes: the multispectral photographing device, and principles and effects thereof are not described herein.

FIG. 11 is a schematic diagram of an unmanned aerial vehicle 110 according to an embodiment of this application. As shown in FIG. 11, the unmanned aerial vehicle includes: a rack 111, a power apparatus 112, and the multispectral photographing device 113 in the corresponding embodiment of FIG. 8 or FIG. 9. The power apparatus 112 is disposed on the rack 111 and is configured to drive the unmanned aerial vehicle to fly. The multispectral photographing device 113 is disposed on the rack 111.

Optionally, the unmanned aerial vehicle may further include a gimbal. The gimbal is configured to be connected to the multispectral photographing device 113, for stabilizing photographing of the multispectral photographing device 113.

Optionally, the unmanned aerial vehicle may further include a flight control system, a vision system, an image transmission system, a battery system, etc., and the descriptions thereof are omitted herein.

The unmanned aerial vehicle provided in this application includes a multispectral photographing device. The device is configured to perform the control method for a photographing apparatus, and principles and effects thereof are not described herein.

This application provides a storage medium, including an instruction, the instruction being used to implement the multispectral photographing method provided in this application.

This application provides a computer program product, including: a computer program, the computer program being used to implement the control method for a photographing apparatus provided in this application.

A person of ordinary skill in the art may understand that all or some of the steps for implementing the above embodiments of the methods can be accomplished through hardware related to program instructions. The program can be stored in a computer-readable storage medium. When executed, the program executes the steps include the above embodiments of the methods. The storage medium includes various media that can store program codes such as a ROM, a RAM, a magnetic disk, or an optical disc.

Finally, it should be noted that, the above embodiments are merely used to describe the technical solutions of the present invention, but are not intended to limit the present invention. It should be understood by a person of ordinary skill in the art that although the present invention has been described in detail with reference to the above embodiments, modifications can still be made to the technical solutions described in the above embodiments, or equivalent replacements can be made to some or all of the technical features therein. Such modifications or replacements do not make the essence of the corresponding technical solutions depart from the scope of the technical solutions of the embodiments of the present invention.

What is claimed is:

1. A control method for a photographing apparatus, comprising:
transmitting a synchronization signal to a main photographing apparatus and at least one auxiliary photographing apparatus;
acquiring a first image collected by the main photographing apparatus according to the synchronization signal, and acquiring a second image collected by the at least one auxiliary photographing apparatus according to the synchronization signal; and
synchronously storing the first image and the second image into a storage unit through a first read-write buffer area.

2. The method according to claim 1, wherein the acquiring a first image collected by the main photographing apparatus according to the synchronization signal comprises:
acquiring a first image associated with the synchronization signal in N frames of images collected by the main photographing apparatus.

3. The method according to claim 2, wherein the acquiring a second image collected by the at least one auxiliary photographing apparatus according to the synchronization signal comprises:
acquiring a second image collected by the at least one auxiliary photographing apparatus after being triggered by the synchronization signal.

4. The method according to claim 1, wherein the synchronously storing the first image and the second image into a storage unit through a first read-write buffer area comprises:
buffering the first image and the second image into the first read-write buffer area; and
extracting at least two frames of images buffered from the first read-write buffer area, and storing the at least two frames of images into the storage unit,
wherein the at least two frames of images are from at least two photographing apparatuses respectively.

5. The method according to claim 1, wherein the method further comprises:
processing the first image and the second image respectively; and
the synchronously storing the first image and the second image into a storage unit through a first read-write buffer area comprises:
synchronously storing the processed first and second images into the storage unit through the first read-write buffer area.

6. The method according to claim 5, wherein the processing the first image and the second image respectively comprises:
converting the first image into first YUV data; and
converting the second image into second YUV data, and extracting Y-component data from the second YUV data.

7. The method according to claim 6, wherein the method further comprises:
converting the first YUV data into a file in a first format, and converting the Y-component data into a file in a second format, wherein a compression rate of the first format is greater than that of the second format; and
the synchronously storing the processed first and second images into the storage unit through the first read-write buffer area comprises:
synchronously storing the file in the first format and the file in the second format into the storage unit through the first read-write buffer area.

8. The method according to claim 5, wherein the processing the first image and the second image respectively comprises:
converting the first image into first YUV data; and
converting the second image into second YUV data.

9. The method according to claim 8, wherein the method further comprises:
converting the first YUV data into a file in a first format, and converting the Y-component data into a file in a second format,
wherein a compression rate of the first format is greater than that of the second format; and
the synchronously storing the processed first and second images into the storage unit through the first read-write buffer area comprises:
synchronously storing the file in the first format and the file in the second format into the storage unit through the first read-write buffer area.

10. The method according to claim 1, further comprising:
acquiring real-time images collected by the main photographing apparatus and/or the at least one auxiliary photographing apparatus;
buffering the real-time images into a second read-write buffer area;
extracting at least one frame of image from the second read-write buffer area; and
transmitting the at least one frame of image to a display terminal, the display terminal being configured to display the at least one frame of image.

11. The method according to claim 10, further comprising:
processing the real-time images; and
the buffering the real-time images into a second read-write buffer area comprises:
buffering the processed real-time images into the second read-write buffer area.

12. A multispectral photographing device, comprising: a processor, a main photographing apparatus, and at least one auxiliary photographing apparatus;
the processor being configured to:
transmit a synchronization signal to a main photographing apparatus and at least one auxiliary photographing apparatus;
acquire a first image collected by the main photographing apparatus according to the synchronization signal, and acquire a second image collected by the at least one auxiliary photographing apparatus according to the synchronization signal; and
synchronously store the first image and the second image into a storage unit through a first read-write buffer area.

13. The device according to claim 12, wherein the processor is specifically configured to:
acquire a first image associated with the synchronization signal in N frames of images collected by the main photographing apparatus.

14. The device according to claim 13, wherein the processor is specifically configured to:
acquire a second image collected by the at least one auxiliary photographing apparatus after being triggered by the synchronization signal.

15. The device according to claim 12, wherein the processor is specifically configured to:
buffer the first image and the second image into the first read-write buffer area; and
extract at least two frames of images buffered from the first read-write buffer area, and store the at least two frames of images into the storage unit.

16. The device according to claim 12, wherein the processor is further configured to:
process the first image and the second image respectively; and
correspondingly, the processor is specifically configured to synchronously store the processed first and second images into the storage unit through the first read-write buffer area.

17. The device according to claim 16, wherein the processor is specifically configured to:
convert the first image into first YUV data; and
convert the second image into second YUV data, and extract Y-component data from the second YUV data.

18. The device according to claim 17, wherein the processor is further configured to:
convert the first YUV data into a file in a first format, and convert the Y-component data into a file in a second format, wherein a compression rate of the first format is greater than that of the second format; and
correspondingly, the processor is specifically configured to synchronously store the file in the first format and the file in the second format into the storage unit through the first read-write buffer area.

19. The device according to claim 12, further comprising: a transmitter;
the processor being further configured to:
acquire real-time images collected by the main photographing apparatus and/or the at least one auxiliary photographing apparatus;
buffer the real-time images into a second read-write buffer area; and
extract at least one frame of image from the second read-write buffer area; and
the transmitter being configured to:
transmit the at least one frame of image to a display terminal, the display terminal being configured to display the at least one frame of image.

20. An unmanned aerial vehicle, comprising:
a multispectral photographing device,
wherein the multispectral photographing device is configured to:
transmit a synchronization signal to a main photographing apparatus and at least one auxiliary photographing apparatus;
acquire a first image collected by the main photographing apparatus according to the synchronization signal, and acquiring a second image collected by the at least one auxiliary photographing apparatus according to the synchronization signal; and
synchronously store the first image and the second image into a storage unit through a first read-write buffer area.
